(19) United States
(12) Patent Application Publication
(10) Pub. No.: US 2026/0143321 A1
(43) Pub. Date: May 21, 2026

(54) GATT SOLUTION FOR DUAL BLUETOOTH STACK

(71) Applicant: QUALCOMM Incorporated, San Diego, CA (US)

(72) Inventors: Cheng JIANG, Shanghai (CN); Zaiyong CHEN, Shanghai (CN); Chenhong ZHOU, Wuxi (CN); Jiayang MAO, Shanghai (CN)

(21) Appl. No.: 19/125,289

(22) PCT Filed: Dec. 21, 2022
(86) PCT No.: PCT/CN2022/140706

§ 371 Date: Apr. 28, 2025

(51) Int. Cl. H04W 4/80

(52) U.S. Cl. CPC H04W 4/80

(57) ABSTRACT

Various embodiments include methods performed by a computing device for arbitrating General ATTribute (GATT) packets in a dual Bluetooth (BT) stack configuration. Various embodiments may include determining whether an ATTribute (ATT) packet attribute handle is within a first attribute handle range associated with a first BT stack or a second attribute handle range associated with a second BT stack, and transmitting the ATT packet to the first BT stack or the second BT stack based on the attribute handle. Various embodiments may include receiving, from a first BT stack, a Service Discovery Protocol (SDP) request for a remote GATT server, transmitting the SDP request, receiving an SDP response including an SDP result, storing the SDP result, receiving, from a second BT stack, a subsequent SDP request for the remote GATT server, and transmitting the stored SDP result to the second BT stack in response to receiving the subsequent SDP request.

### BACKGROUND

User equipment (UE) and consumer devices for communicating data via Bluetooth (BT)/Bluetooth Low Energy (BLE) have become increasingly complex, especially in devices implementing active mode and low power mode features. In an active mode, an application processor may manage BLE connections and operations of high-performance BT applications. To conserve battery life, a device may transition from the active mode to a low power mode during times in which the high-performance BT applications are not operating or have minimal functionality and processes that may be sufficiently handled by a separate low power processor. In the low power mode, a second processor with limited functionality may manage the baseline operations of the high-performance applications. The low power processor may also wholly manage BT applications that require minimal processing power, therefore eliminating the need to supply operational power to an application processor. Transitioning between an active mode and a low power mode may require significant oversight and computational resources to ensure that BLE context information and other BT data related to the ongoing operations of both BT and BLE applications is not lost, out of synchronization, or redirected to an incorrect BT stack.

### SUMMARY

Various aspects include methods executable by a processor of a computing device configured as a General ATTribute (GATT) server for arbitrating GATT packets in a dual Bluetooth (BT) stack configuration. Various aspects may include determining whether an attribute handle of an ATTribute (ATT) packet is within a first attribute handle range associated with a first BT stack or a second attribute handle range associated with a second BT stack, and either: transmitting the ATT packet to the first BT stack in response to determining that the attribute handle is within the first attribute handle range, or transmitting the ATT packet to the second BT stack in response to determining that the attribute handle is within the second attribute handle range.

Some aspects may further include initializing the first attribute handle range of the first BT stack, and initializing the second attribute handle range of the second BT stack, in which the second attribute handle range is different from the first attribute handle range.

In some aspects, the first attribute handle range may be a range between 0001 and FFFF hexadecimal, and the second attribute handle range may be a range between 0001 and FFFF hexadecimal that does not include the first attribute handle range.

In some aspects, the ATT packet may include ATT opcode including a starting attribute handle and an ending attribute handle, and determining whether the attribute handle of the ATT packet is within the first attribute handle range or the second attribute handle range includes determining whether the starting attribute handle of the ATT packet is within the first attribute handle range or the second attribute handle range.

In some aspects, the first BT stack and the second BT stack may be configured with a same Maximum Transmission Unit (MTU) value. Some aspects may further include transmitting an MTU request message to the first BT stack and the second BT stack, and transmitting an MTU response message associated with the MTU request message to a remote client.

Some aspects may further include receiving a first number of Asynchronous Connection-oriented Logical transport (ACL) packets from a BT stack, storing first ACL source information associated with the first number of ACL packets in a memory, receiving a second number of ACL packets from a BT stack, and storing second ACL source information associated with the second number of ACL packets in the memory. Some aspects may further include recalling the first ACL source information from the memory based on a first number of completed packets (NOCP), transmitting the first NOCP to a BT stack identified by the first ACL source information, recalling the second ACL source information from the memory based on a second NOCP, and transmitting the second NOCP to a BT stack identified by the second ACL source information.

Various aspects include methods executable by a processor of a computing device configured as a GATT client for arbitrating GATT packets in a dual BT stack configuration of a GATT client. Various aspects may include receiving, from a first BT stack, a Service Discovery Protocol (SDP) request for a remote GATT server of a remote device, transmitting the SDP request to the remote device, receiving an SDP response including an SDP result from the remote device, storing the SDP result in memory, receiving, from a second BT stack, a subsequent SDP request for the remote GATT server of the remote device, and transmitting the stored SDP result to the second BT stack in response to receiving the subsequent SDP request.

In some aspects, the first BT stack and the second BT stack may be configured with a same Maximum Transmission Unit (MTU) value. Some aspects may further include receiving, from the first BT stack, an MTU request for the remote GATT server of the remote device, transmitting the MTU request to the remote device, receiving an MTU response including an MTU exchange result from the remote device in response to the MTU request, storing the MTU exchange result in memory, receiving, from the second BT stack, a subsequent MTU request for the remote GATT server of the remote device, and transmitting the stored MTU exchange result to the second BT stack in response to receiving the subsequent MTU request.

Some aspects may further include receiving an ATT command associated with an ATT procedure, initializing the ATT procedure, receiving a subsequent ATT command associated with a subsequent ATT procedure during processing of the ATT procedure, storing in memory the subsequent ATT command, recalling from memory the subsequent ATT command in response to completing the ATT procedure, and initializing the recalled subsequent ATT procedure.

Some aspects may further include receiving a first number of ACL packets from a BT stack, storing first ACL source information associated with the first number of ACL packets in memory, receiving a second number of ACL packets from a BT stack, and storing second ACL source information associated with the second number of ACL packets in the memory.

Some aspects may further include recalling the first ACL source information from the memory based on a first number of completed packets (NOCP), transmitting the first NOCP to a BT stack identified by the first ACL source information, recalling the second ACL source information from the memory based on a second NOCP, and transmitting the second NOCP to a BT stack identified by the second ACL source information.

Further aspects include a computing device (e.g., a Bluetooth integrated circuit) including a processor configured to perform operations of any of the methods summarized above. Further aspects include a computing device including means for performing functions of any of the methods summarized above. Further aspects include a non-transitory processor-readable medium having stored thereon processor-executable instructions configured to cause a processor of a UE to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a system block diagram illustrating an example communication system suitable for implementing any of the various embodiments.

FIG. 2 is a component block diagram illustrating an example computing device suitable for implementing any of the various embodiments.

FIG. 3 is a component block diagram illustrating an example system for arbitrating General ATTribute (GATT) packets in a dual Bluetooth (BT) stack configuration according to some embodiments.

FIG. 4 is a component block diagram illustrating an example BT/Bluetooth Low Energy (BLE) system architecture according to some embodiments.

FIG. 5A is a process flow diagram of an example method that may be performed by a computing device for arbitrating GATT packets in a dual BT stack configuration of a GATT server in accordance with various embodiments.

FIGS. 5B and 5C are process flow diagrams of example operations that may be performed as part of the method illustrated in FIG. 5A as described for arbitrating GATT packets in a dual BT stack configuration of a GATT server in accordance with some embodiments.

FIG. 6A is a process flow diagram of an example method that may be performed by a computing device for arbitrating GATT packets in a dual BT stack configuration of a GATT client in accordance with various embodiments.

FIGS. 6B and 6C are process flow diagrams of example operations that may be performed as part of the method illustrated in FIG. 6A as described for arbitrating GATT packets in a dual BT stack configuration of a GATT client in accordance with some embodiments.

FIGS. 7A and 7B are process flow diagrams of example operations that may be performed as part of the methods illustrated in FIGS. 5A and 6A as described for arbitrating GATT packets in a dual BT stack configuration of a GATT server and/or GATT client in accordance with some embodiments.

FIG. 8 is a component block diagram illustrating an example computing device suitable for use with the various embodiments.

FIG. 9 is a component block diagram illustrating an example wireless communication device suitable for use with the various embodiments.

FIG. 10 illustrates an example wearable computing device in the form of a smart watch according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include Bluetooth (BT) devices and methods and BT processors that arbitrate ATTribute (ATT) and/or General ATT (GATT) packets in a dual BT stack configuration including a low power processor BT stack and an application processor BT stack. Some embodiments include operations to arbitrate ATT/GATT packets based on attribute handle ranges associated with either BT stack within a dual BT stack configuration for a GATT server. Some embodiments include maintaining a Service Discovery Protocol (SDP) result cache for reducing the number of SDP procedures performed within a dual BT stack configuration for a GATT client. Various embodiments include maintaining a record of ACL source information for routing a number of completed packets (NOCP) to the correct BT stack. Various embodiments may be implemented by a BT controller, a processor implementing an arbitration layer, and/or a BT controller implementing the arbitration layer.

The term “system-on-a-chip” (SoC) is used herein to refer to a single integrated circuit (IC) chip that contains multiple resources and/or processors integrated on a single substrate. A single SoC may contain circuitry for digital, analog, mixed-signal, and radio-frequency functions. A single SoC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SoCs may also include software for controlling the integrated resources and processors, as well as for controlling peripheral devices.

The term “system-in-a-package” (SIP) may be used herein to refer to a single module or package that contains multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SoCs coupled together via high-speed communication circuitry and packaged in close proximity, such as on a single motherboard or in a single computing device. The proximity of the SoCs facilitates high speed communications and the sharing of memory and resources.

The term “BT data” may be used herein to refer to any data received or transmitted across a BT/Bluetooth Low Energy (BLE) connection and any information associated with conveying data across said BT/BLE connection. Specifically, BT data may refer to any data (e.g., data packets) received or transmitted across a BT or BLE connection to an endpoint (e.g., BT/BLE application). BT data may also refer to any information used to establish and maintain BT/BLE connections and to communicate data packets through various layers of a BT/BLE stack (e.g., BT controller, Host, applications) of a processor (e.g., low power processor, high-performance, or application, processor), such as packet header information, system information blocks, system integrity information such as number of completed packets (NoCP), service discovery protocol (SDP) information, packet identifiers, attribute handles, connection handles, and channel identifiers associated with BT data packets.

An increased number of wireless-capable devices are being developed that require or support high-performance operations. As a result of implementing increasingly complex processors, power consumption within these devices has increased. Increased power consumption is especially problematic in smaller devices, such as wearable devices that are battery-powered, including smart watches, virtual reality (VR) goggles, smart glasses, and medical devices that typically utilize small-profile rechargeable batteries due to physical design constraints. Such devices often utilize BT and/or BT Low Energy (BLE) to convey information with another paired device. Advertising and scanning for devices, and establishing and maintaining a BT/BLE connection may further increase power consumption within a given device.

To accommodate this increase in power demand, wearable devices are being designed with two processors, an application, or high-performance, processor for managing operations of high-performance BT applications during an active, or high-performance, mode, and a low-power BT processor for managing low power BT applications and also baseline device operations during a low power mode when the high-performance BT applications are not requiring an advanced level of processing power. In some implementations, a high-performance BT processor and a low-power BT processor may be included in a single SoC, in portions of a single SIP, in coupled integrated circuits, or in different components within a wireless device. For ease of reference, the term “computing device” is used herein to refer to any implementation of high-performance and low-performance BT processors, including single SoC implementations, portions of an SIP, coupled ICs and wireless device incorporating such processors.

Typically, in low power mode, the application processor is turned off or in a sleep mode, and the low power processor takes over control of device operations. When a BT/BLE application requires an advanced degree and/or amount of processing, the application processor may activate or wake up, and enter the active mode. Such devices frequently transition processing of BT/BLE applications from the low power processor back to the application processor and vice versa in order to minimize power consumption.

A computing device (e.g., a BT SoC) including a low power processor and an application processor both processor may be active in a same instance, for example, during the transition between low power mode and active modes during which the low power processor and the application processor must share BT data and/or context information for synchronization purposes. During this period in which a BT stack of the low power processor and a BT stack of the application processor are both active, a BT controller and/or an arbitration layer may route BT data and BT context information to the appropriate BT stack, either the BT stack of the low power processor or the BT stack of the application processor.

For different remote devices paired with a BT device, a connection handle may be used to route any BT packets received from the various remote devices. Conventionally, Logical Link Control and Adaptation Layer Protocol (L2CAP) or Radio Frequency Communication (RFCOMM) packets from a same remote may use a Channel Identification (CID) or Data Link Connection Identifier (DLCI) to distinguish between different profiles and applications, such that the CID and/or DLCI may be used to arbitrate a received packet to the proper BT stack.

General ATTribute (GATT) profiles can be implemented within a BT device configured as either a GATT server or GATT client. A GATT profile may define the way in which two BT devices transfer data back and forth using concepts called Services and Characteristics. A GATT profile may implement a generic data protocol called the Attribute Protocol (ATT), which is used to store Services, Characteristics, and related data in a simple lookup table using 16-bit IDs for each entry in the table.

Implementing a dual BT stack configuration poses a number of problems when arbitrating packets properly to either the low power processor BT stack, the application processor BT stack, or both stacks. For example, all ATT/GATT packets use the same CID (e.g., 0x0004), so CID may not be used to arbitrate packets in a dual BT stack solution, and therefore may not be routed properly (i.e., to the BT stack that initiated a request to a remote BT device or responded to a request from a remote BT device). As another example, ATT Maximum Transmission Unit (MTU) may be negotiated only once after connecting, meaning that only one BT stack can issue the ATT MTU negotiation. Additionally, ATT uses a sequential transaction model, meaning that if an ATT transaction has been started, no further ATT Protocol Data Units (PDUs) may be processed by the BT stack until the current transaction has been completed. Furthermore, since an ATT packet is based on L2CAP, a number of completed packets (NOCP) needs to be sent to the correct BT stack. However, the NOCP contains no information indicating which BT stack the NOCP should be routed to.

Various embodiments include methods and computing devices configured as either a GATT server or GATT client to address the aforementioned issues that arise when arbitrating GATT packets in a dual BT stack configuration. The various embodiments allow for arbitrating BT data and BT context information including ATT/GATT packets to the appropriate BT stack (i.e., low power processor BT stack and/or the application processor BT stack) in a computing device implementing a dual BT stack.

For example, a computing device configured as a GATT server may include a first processor including a first BT stack associated with a first attribute handle range, a second processor including a second BT stack associated with a second attribute handle range, and interface circuitry (i.e., BT controller, processor implementing an arbitration layer, and/or BT controller implementing an arbitration layer) communicatively coupled to the first BT stack and the second BT stack. The interface circuitry may be configured to determine whether an attribute handle of an ATT packet is within the first attribute handle range or the second attribute handle range; and either: transmit the ATT packet to the first BT stack in response to determining that the attribute handle is within the first attribute handle range, or transmit the ATT packet to the second BT stack in response to determining that the attribute handle is within the second attribute handle range.

In some embodiments, the ATT packet may include ATT opcode including a starting attribute handle and an ending attribute handle. In some embodiments, the interface circuitry may be configured to determine whether the attribute handle of the ATT packet is within the first attribute handle range or the second attribute handle range based on whether the starting attribute handle of the ATT packet is within the first attribute handle range or the second attribute handle range. In some embodiments, the first BT stack and the second BT stack may be configured with a same MTU value, and the interface circuitry may be further configured to transmit an MTU request message to the first BT stack and the second BT stack, and transmit an MTU response message associated with the MTU request message to a remote client. In some embodiments, the second processor (i.e., low power processor) may manage a Common Profile including at least one of a General Access Profile (GAP) service or Device Information Service (DIS).

In some embodiments, the interface circuitry may be further configured to receive a first number of Asynchronous Connection-oriented Logical transport (ACL) packets from a BT stack, store first ACL source information associated with the first number of ACL packets in a memory, receive a second number of ACL packets from a BT stack, and store second ACL source information associated with the second number of ACL packets in the memory. In some embodiments, the interface circuitry may be further configured to recall the first ACL source information from the memory based on a first NOCP, transmit the first NOCP to a BT stack identified by the first ACL source information, recall the second ACL source information from the memory based on a second NOCP, and transmit the second NOCP to a BT stack identified by the second ACL source information.

As another example, a computing device configured as a GATT client may include a first processor including a first BT stack, a second processor including a second BT stack, and an interface circuitry communicatively coupled to the first BT stack and the second BT stack. The interface circuitry may be configured to receive, from the first BT stack, a Service Discovery Protocol (SDP) request for a remote GATT server of a remote device, transmit the SDP request to the remote device, receive an SDP response including an SDP result from the remote device, store the SDP result in memory (e.g., SDP result cache), receive, from the second BT stack, a subsequent SDP request for the remote GATT server of the remote device, and transmit the stored SDP result to the second BT stack in response to receiving the subsequent SDP request. The interface circuitry may be further configured to transmit the SDP result to the first BT stack as well (i.e., in response to receiving the SDP response initially prior to or at the same time as storing the SDP result in memory). In some embodiments, SDP procedures may be considered integrated transactions.

In some embodiments, the first BT stack and the second BT stack may be configured with a same MTU value, and the interface circuitry may be configured to receive, from the first BT stack, an MTU request for a remote GATT server of the remote device, transmit the MTU request to the remote device, receive an MTU response including an MTU exchange result from the remote device in response to the MTU request, store the MTU exchange result in memory, receive, from the second BT stack, a subsequent MTU request for the remote GATT server of the remote device, and transmit the stored MTU exchange result to the second BT stack in response to receiving the subsequent MTU request.

In some embodiments, the interface circuitry may be further configured to receive an ATT command associated with an ATT procedure, initialize the ATT procedure, receive a subsequent ATT command associated with a subsequent ATT procedure during processing of the ATT procedure, store, in memory, the subsequent ATT command, recall, from memory, the subsequent ATT command in response to completing the ATT procedure, and initialize the recalled subsequent ATT procedure.

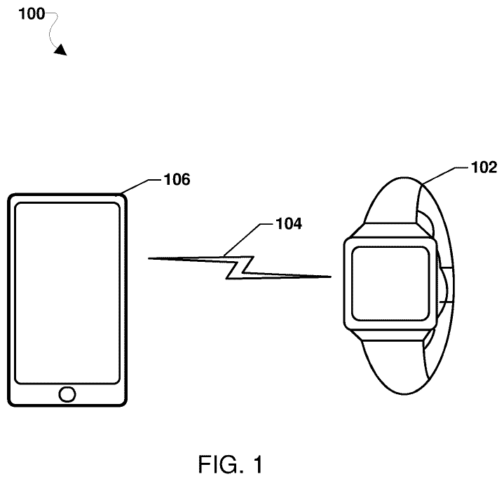

FIG. 1 is a system block diagram illustrating an example communication system suitable for implementing any of the various embodiments. The communication system 100 may be a short-range communications network including multiple devices capable of wireless communication. For example, the communication system 100 may be a BT/BLE communication system including a first BT device 102 and second BT device 106.

The first BT device 102 may be any type of computing device capable of BT/BLE communications, such as a wearable device (e.g., smart watch, smart glasses, virtual reality systems, and medical devices such as heart monitors). The second BT device 106 may be any type of computing device capable of BT/BLE communications that is communicatively compatible with the first BT device 102. The first BT device 102 may be communicatively coupled to the second BT device 106 via wireless connection 104, which may be a BT/BLE wireless connection. For ease of illustration, the communication system 100 includes one communicatively connected, or paired, BT device 106. However, more paired BT device 106 may be implemented within the communications system 100. For example, the first BT device 102 may be paired with multiple BT devices simultaneously including the second BT device 106 and additional BT devices of a same or different type (e.g., cellular phone, laptop computer, multimedia displays, other wearable device such as audio output devices, Point-of-Sale systems) that are capable of BT/BLE communications.

The wireless connection 104 may be a BT/BLE connection established via handshaking processes between the first BT device 102 and the second BT device 106. The first BT device 102 may query or otherwise determine a preferred connection type, such as a codec type, of each discoverable BT device within communications range, including the second BT device 106, and may establish each a wireless connection 104 according to each preferred connection type. For example, the wireless connection 104 may be established based at least on a preferred codec type implemented by the second BT device 106.

The first BT device 102 may transmit BT data to and receive BT data from the second BT device 106 according to the specific protocols and connection type of the wireless connection 104. For example, the first BT device 102 may encode BT data (e.g., audio data) to be transmitted to the second BT device 106 via the wireless connection 104, and transmit the encoded BT data to the second BT device 106 via the wireless connection 104. After receiving the encoded BT data, the second BT device 106 may decode the encoded BT data for use in various BT/BLE applications or applications that may utilize BT data. Similarly, the second BT device 106 may encode BT data and transmit the encoded BT data to the first BT device 102 via the wireless connection 104. After receiving the encoded BT data, the first BT device 102 may decode the encoded BT data for use in various BLE applications or applications that may utilize BT data. BT data may include data such as context information for both classic BT (i.e., BR/EDR data) and BLE operations. For example, BT data may refer to BR/EDR context information during an active mode of operation, and BT data may also refer to BLE context information during a low power mode of operation.

The first BT device 102 may function in various BT/BLE modes as defined by Bluetooth Core Specification v5.3. For example, the first BT device 102 may function and perform operations in an active mode (i.e., high-performance mode) or a low power mode (i.e., sleep mode, low-performance mode). The first BT device 102 may include two or more processors, which may be utilized depending on the mode of operation. For example, the first BT device 102 may include a low power processor that may perform BLE functions during a low power mode, and an application processor (i.e., performance processor) that may perform functions alongside the low power processor during an active mode. Thus, the first BT device 102 may conserve battery life by when in a low power mode by utilizing only the low power processor, and may perform BT operations when in an active mode by utilizing the application processor.

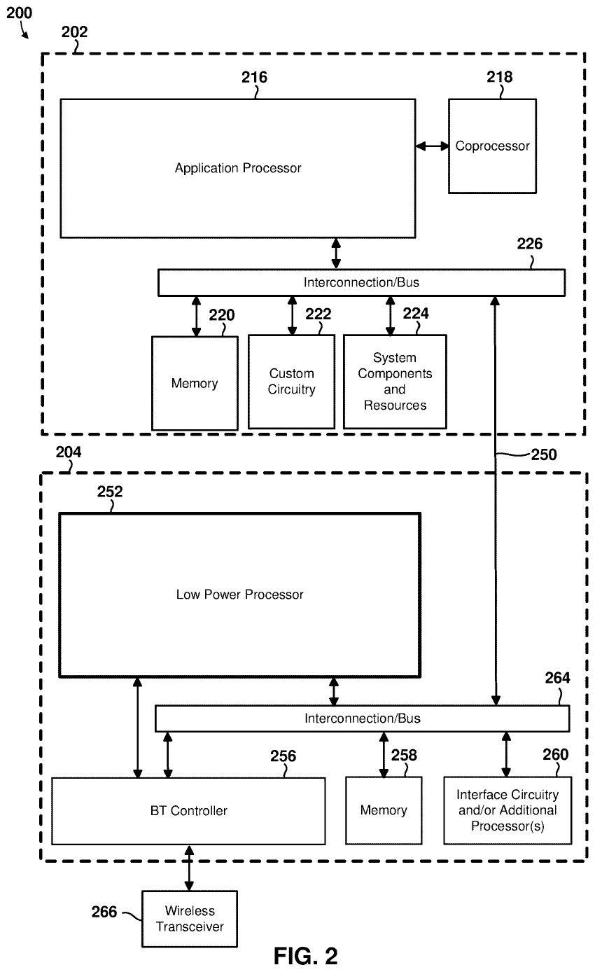

FIG. 2 is a component block diagram illustrating an example computing device 200 suitable for implementing any of the various embodiments. Various embodiments may be implemented on a number of single processor and multiprocessor computer systems, including a system-on-chip (SoC) or system in a package. The computing device 200 may be implemented as a wearable device or BT/BLE-capable device (e.g., first BT device 102, second BT device 106).

With reference to FIGS. 1-2, the illustrated example computing device 200 (which may be a system-in-a-package in some embodiments) includes first circuitry 202 (e.g., low power mode circuitry and components) communicably coupled to second circuitry 204 (e.g., active mode circuitry and components). In some embodiments, the first circuitry 202 may include components that operate as a processing unit of the computing device 200 that carries out the instructions of software application programs by performing the arithmetic, logical, control and input/output (I/O) operations specified by the instructions. In some embodiments, the second circuitry 204 may include components that operate as a processing unit for managing BT/BLE operations during a low power mode of operation and during transitions between a low power mode and an active mode in which the first circuitry 202 is activated.

The first circuitry 202 may include an application processor (AP) 216, one or more coprocessors 218 (e.g., vector co-processor) connected to one or more of the processors, memory 220, custom circuity 222, system components and resources 224, and an interconnection/bus module 226. The second circuitry 204 may include a low power processor 252, an interconnection/bus module 264, a BT controller 256, memory 258, and interface circuitry and/or various additional processors 260, such as a packet processor. The BT controller 256 may be communicably coupled to a wireless transceiver 266, and may be configured to transmit and receive BT data to and from the wireless transceiver 266. The wireless transceiver 266 may be configured to transmit and receive wireless communications (e.g., BT messages including BT data and context information) via an antenna (not shown) to/from wireless computing devices, such as a BT/BLE-capable wireless device (e.g., second BT device 106).

Each processor 216, 218, 252, 260 may include one or more cores, and each processor/core may perform operations independent of the other processors/cores. For example, the first circuitry 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 216, 218, 252, 260 may be included as part of a processor cluster architecture (e.g., a synchronous processor cluster architecture, an asynchronous or heterogeneous processor cluster architecture, etc.).

The first and second circuitries 202, 204 may include various system components, resources, and custom circuitry for managing sensor data, analog-to-digital conversions, wireless data transmissions, and for performing other specialized operations, such as decoding data packets and processing encoded audio and video signals for rendering in a web browser or audio/video application. For example, the system components and resources 224 of the first circuitry 202 may include power amplifiers, voltage regulators, oscillators, phase-locked loops, peripheral bridges, data controllers, memory controllers, system controllers, access ports, timers, and other similar components used to support the processors and software clients running on a computing device. The system components and resources 224 and/or custom circuitry 222 may also include circuitry to interface with peripheral devices, such as cameras, electronic displays, wireless communication devices, external memory chips, etc.

The first and second circuitries 202, 204 may communicate via interconnection/bus module 250. In some embodiments, the interconnection/bus module 250 may be a connection established by transceiving (i.e., receiving and transmitting) components within both the first circuitry 202 and second circuitry 204. For example, the low power processor 252 may include a universal asynchronous receiver-transmitter (UART) and the application processor 216 may include a multiple signal messages (MSM) UART driver that is communicatively connected to the UART of the low power processor 252.

The various processors 216, 218, may be interconnected to one or more memory elements 220, system components and resources 224, and custom circuitry 222 via an interconnection/bus module 226. Similarly, the low power processor 252 may be interconnected to the BT controller 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second circuitries 202, 204 may further include an input/output module (not illustrated) for communicating with resources external to the circuitries 202, 204, such as a clock, a voltage regulator, one or more wireless transceivers 266, and/or a subscriber identity module (SIM) and/or SIM interface (i.e., an interface for receiving one or more SIM cards). Resources external to the circuitries 202, 204 may be shared by two or more of the internal processors/cores.

The interface circuitry and/or additional processors 260 may be configured to perform various operations for arbitrating GATT packets in a dual BT stack configuration, in which the low power processor 252 implements a first BT stack and the application processor 216 implements a second BT stack. In some embodiments, the interface circuitry and/or additional processors 260 may include the BT controller 256 and all functions thereof, in which the interface circuitry and/or additional processors 260 is configured to transceive BT data with the wireless transceiver 256 and the BT stacks of the low power processor 252 and the application processor 216. In some embodiments, the interface circuitry and/or additional processors 260 may be configured to implement an arbitration layer for routing BT data between the BT stacks and the wireless transceiver 266. In some embodiments, the interface circuitry and/or additional processors 260 may include the interconnection/bus modules 226, 250, 264 for routing BT data between the BT stacks and the BT controller 256 (i.e., in embodiments in which the BT controller 256 is not a component of the interface circuitry and/or additional processors 260) or wireless transceiver 266 (i.e., in embodiments in which the BT controller 256 is a component of the interface circuitry and/or additional processors 260). In some embodiments, the interface circuitry and/or additional processors 260 may be included within the low power processor 252.

In addition to the example computing device 200 discussed above, various embodiments may be implemented in a wide variety of computing systems, which may include a single processor, multiple processors, multicore processors, or any combination thereof.

In some embodiments, the various processors of the first circuitry 202 and second circuitry 204 may be located within a same SoC. For example, the application processor 216 and low power processor 252 may be located within a same SoC, such as in a single SoC of a wearable device, to perform BT/BLE functions in both a low power mode (i.e., low power processor 252 is utilized) and an active mode (i.e., application processor is activated and utilized). As another example, a computing device, such as a wearable device (e.g., first BT device 102), may include one SoC including the first circuitry 202 and the second circuitry 204 to perform BT/BLE functions in both a low power mode and an active mode, in which the low power processor 252 is utilized during a low power mode, and the application processor 216 is activated and utilized during an active mode.

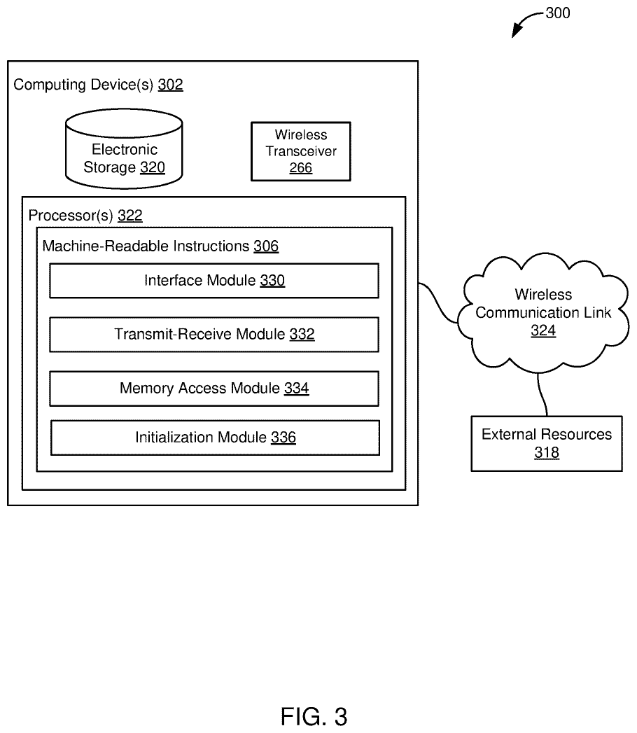

FIG. 3 is a component block diagram illustrating an example system 300 for arbitrating GATT packets in a dual BT stack configuration according to some embodiments. With reference to FIGS. 1-3, the system 300 may include one or more computing device(s) 302 (e.g., the first BT device 102, computing device 200) and external resources 318, which may communicate via a wireless communication link 324 (e.g., wireless connection 104). External resources 318 may include sources of information outside of the system 300, external entities participating with the system 300, or other resources. For example, external resources 318 may be a paired BT device such as the second BT device 106. In some implementations, some or all of the functionality attributed herein to external resources 318 may be provided by resources included in the system 300. The system 300 may include a plurality of hardware, software, and/or firmware components operating together to provide the functionality attributed herein to the processor 322.

The computing device(s) 302 may include electronic storage 320 that may be configured to store information related to functions implemented by an interface module 330, a transmit-receive module 332, a memory access module 334, an initialization module 336, and any other instruction modules.

The electronic storage 320 may include non-transitory storage media that electronically stores information. The electronic storage 320 may include one or both of system storage that is provided integrally (i.e., substantially non-removable) with the system 200 and/or removable storage that is removably connectable to the system 200 via, for example, a port (e.g., a universal serial bus (USB) port, a firewire port, etc.) or a drive (e.g., a disk drive, etc.).

In various embodiments, electronic storage 320 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media. The electronic storage 320 may include one or more virtual storage resources (e.g., cloud storage, a virtual private network, and/or other virtual storage resources). The electronic storage 320 may store software algorithms, information determined by processor(s) 322, and/or other information that enables the system 300 to function as described herein.

The computing device(s) 302 may be configured by machine-readable instructions 306. Machine-readable instructions 306 may include one or more instruction modules. The instruction modules may include computer program modules. The instruction modules may include one or more of the interface module 330, the transmit-receive module 332, the memory access module 334, the initialization module 336, and other instruction modules (not illustrated). The computing device(s) 302 may include processor(s) 322 configured to implement the machine-readable instructions 306 and corresponding modules.

The processor(s) 322 may include one of more local processors that may be configured to provide information processing capabilities in the system 300. As such, the processor(s) 322 may include one or more of a digital processor, an analog processor, a digital circuit designed to process information, an analog circuit designed to process information, a state machine, and/or other mechanisms for electronically processing information. Although the processor(s) 322 is shown in FIG. 3 as a single entity, this is for illustrative purposes only. In some embodiments, the processor(s) 322 may include a plurality of processing units. These processing units may be physically located within the same device, or the processor(s) 322 may represent processing functionality of a plurality of devices distributed in the system 300.

In some embodiments, the processor(s) 322 executing the interface module 330 may be configured to determine whether an attribute handle of an ATT packet is within a first attribute handle range associated with a first BT stack or a second attribute handle range associated with a second BT stack.

In some embodiments, the processor(s) 322 executing the interface module 330 and/or the transmit-receive module 332 may be configured to transmit the ATT packet to the first BT stack in response to determining that the attribute handle is within the first attribute handle range. In some embodiments, the processor(s) 322 executing the interface module 330 and/or the transmit-receive module 332 may be configured to transmit the ATT packet to the second BT stack in response to determining that the attribute handle is within the second attribute handle range.

In some embodiments, the processor(s) 322 executing the interface module 330 and/or the transmit-receive module 332 may be configured to transmit an MTU request message to the first BT stack and the second BT stack. In some embodiments, the processor(s) 322 executing the interface module 330 and/or the transmit-receive module 332 may be configured to transmit an MTU response message associated with the MTU request message to a remote client.

In some embodiments, the processor(s) 322 executing the interface module 330 and/or the transmit-receive module 332 may be configured to receive a first number of ACL packets from a BT stack. In some embodiments, the processor(s) 322 executing the interface module 330 and/or the transmit-receive module 332 may be configured to transmit the first NOCP to a BT stack identified by the first ACL source information. In some embodiments, the processor(s) 322 executing the interface module 330 and/or the transmit-receive module 332 may be configured to transmit the second NOCP to a BT stack identified by the second ACL source information.

In some embodiments, the processor(s) 322 executing the interface module 330 and/or the transmit-receive module 332 may be configured to receive, from a first BT stack, an SDP request for a remote GATT server of a remote device. In some embodiments, the processor(s) 322 executing the interface module 330 and/or the transmit-receive module 332 may be configured to transmit the SDP request to the remote device. In some embodiments, the processor(s) 322 executing the interface module 330 and/or the transmit-receive module 332 may be configured to receive an SDP response including an SDP result from the remote device. In some embodiments, the processor(s) 322 executing the interface module 330 and/or the transmit-receive module 332 may be configured to receive, from a second BT stack, a subsequent SDP request for the remote GATT server of the remote device. In some embodiments, the processor(s) 322 executing the interface module 330 and/or the transmit-receive module 332 may be configured to transmit the stored SDP result to the second BT stack in response to receiving the subsequent SDP request. In some embodiments, the processor(s) 322 executing the interface module 330 and/or the transmit-receive module 332 may be configured to transmit the stored SDP result to the first BT stack.

In some embodiments, the processor(s) 322 executing the interface module 330 and/or the transmit-receive module 332 may be configured to receive, from the first BT stack, an MTU request for the remote GATT server of the remote device. In some embodiments, the processor(s) 322 executing the interface module 330 and/or the transmit-receive module 332 may be configured to transmit the MTU request to the remote device. In some embodiments, the processor(s) 322 executing the interface module 330 and/or the transmit-receive module 332 may be configured to receive an MTU response including an MTU exchange result from the remote device in response to the MTU request. In some embodiments, the processor(s) 322 executing the interface module 330 and/or the transmit-receive module 332 may be configured to receive, from the second BT stack, a subsequent MTU request for the remote GATT server of the remote device. In some embodiments, the processor(s) 322 executing the interface module 330 and/or the transmit-receive module 332 may be configured to transmit the stored MTU exchange result to the second BT stack in response to receiving the subsequent MTU request.

In some embodiments, the processor(s) 322 executing the interface module 330 and/or the transmit-receive module 332 may be configured to receive an ATT command associated with an ATT procedure. In some embodiments, the processor(s) 322 executing the interface module 330 and/or the transmit-receive module 332 may be configured to receive an ATT command associated with an ATT procedure.

In some embodiments, the processor(s) 322 executing the interface module 330 and/or the memory access module 334 may be configured to store first ACL source information associated with the first number of ACL packets in a memory. In some embodiments, the processor(s) 322 executing the interface module 330 and/or the memory access module 334 may be configured to store second ACL source information associated with the second number of ACL packets in the memory. In some embodiments, the processor(s) 322 executing the interface module 330 and/or the memory access module 334 may be configured to recall the first ACL source information from the memory based on a first NOCP. In some embodiments, the processor(s) 322 executing the interface module 330 and/or the memory access module 334 may be configured to recall the second ACL source information from the memory based on a second NOCP. In some embodiments, the processor(s) 322 executing the interface module 330 and/or the memory access module 334 may be configured to store the SDP result in memory. In some embodiments, the processor(s) 322 executing the interface module 330 and/or the memory access module 334 may be configured to store the MTU exchange result in memory. In some embodiments, the processor(s) 322 executing the interface module 330 and/or the memory access module 334 may be configured to store, in memory, the subsequent ATT command. In some embodiments, the processor(s) 322 executing the interface module 330 and/or the memory access module 334 may be configured to recall, from memory, the subsequent ATT command in response to completing the ATT procedure.

In some embodiments, the processor(s) 322 executing the interface module 330 and/or the initialization module 336 may be configured to initialize the first attribute handle range of the first BT stack. In some embodiments, the processor(s) 322 executing the interface module 330 and/or the initialization module 336 may be configured to initialize the second attribute handle range of the second BT stack, in which the second attribute handle range is different from the first attribute handle range. In some embodiments, the processor(s) 322 executing the interface module 330 and/or the initialization module 336 may be configured to initialize the ATT procedure. In some embodiments, the processor(s) 322 executing the interface module 330 and/or the initialization module 336 may be configured to initialize the recalled subsequent ATT procedure.

The processor(s) 322 may execute the modules 330-336 and/or other modules by software, hardware, firmware, some combination of software, hardware, and/or firmware, and/or other mechanisms for configuring processing capabilities on processor(s) 322.

The description of the functionality provided by the different modules 330-336 is for illustrative purposes, and is not intended to be limiting, as any of modules 330-336 may provide more or less functionality than is described. For example, one or more of modules 330-336 may be eliminated, and some or all of its functionality may be provided by other ones of modules 330-336. As another example, processor(s) 322 may execute one or more additional modules that may perform some or all of the functionality attributed below to one of modules 330-336.

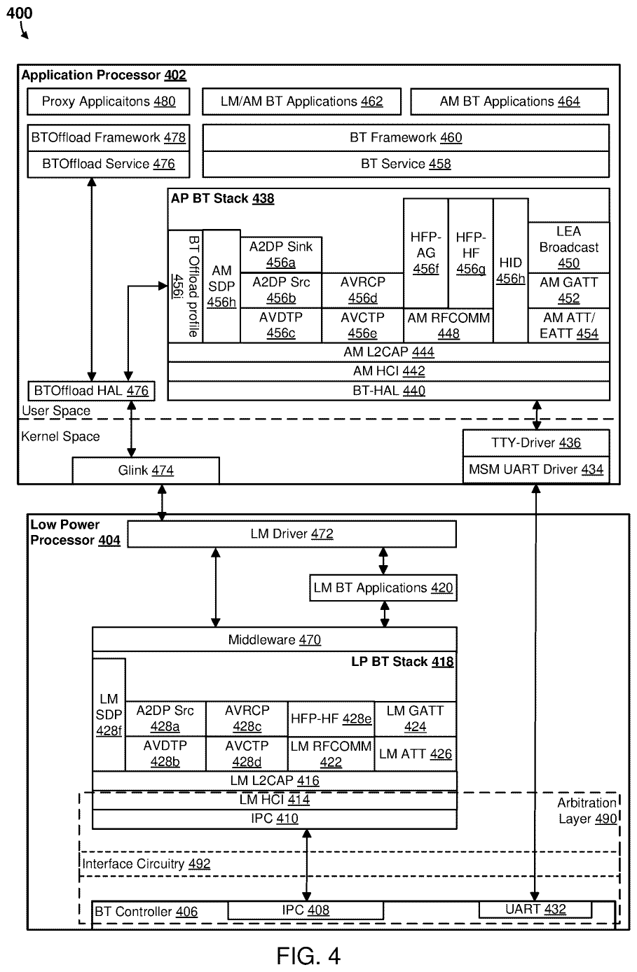

FIG. 4 is a component block diagram illustrating an example BT/BLE system architecture 400 including a stack configuration according to some embodiments. The BT/BLE system architecture 400 may be implemented on an application processor 402 (e.g., application processor 216, application processor of additional processors 260) and a low power processor (e.g., low power processor 252) of a BT device (e.g., first BT device 102, computing device 200, 302). The application processor 402 may be activated, or otherwise powered on or awoken, to perform BT-related operations during a BT active mode. During a BLE low power mode, or sleep mode, the application processor 402 may be deactivated, powered off, or may enter a sleep (low power) state, and the low power processor 404 may perform BLE-related operations.

The application processor 402 may include an active mode AP BT stack 438 (e.g., Fluoride, BlueZ, FreeBSD, Mac OS X, Microsoft BT stack, BlueCode+, etc.) that supports operations of low power mode (LM)/AM BT applications 462 that may be executed in both an LM and AM. The application processor may further support operations of AM BT applications 464 and proxy applications 480 that may be executed in an AM. The low power processor 404 may include a low power (LP) BT stack 418 that supports operations of LM BT applications 420 that run solely during a LM. The application processor 402 may include BT Service 458 and BT Framework 460 to support LM/AM BT applications 462 and AM BT applications 464, and may further include BTOffload Service 576 and BTOffload Framework 478 to support the proxy applications 480. The BT framework 460 and BTOffload Framework 478 may be application code that may utilize BT application programming interfaces (APIs) to interact with BT hardware. The BT Service 458 may interface the BT Framework 460 with the AP BT stack 438, and the BTOffload Service 476 may interface the BTOffload Framework 478 with the AP BT stack 438.

The low power processor 404 may include a BT controller 406 for interfacing and communicating with one or more paired BT devices (e.g., second BT device 106). The BT controller 406 may include a communication interface, such as an inter process communication (IPC) module 408 and a universal asynchronous receiver-transmitter (UART) 432. The IPC module 408 may be configured to receive BT data (e.g., BT context information) from another BT device (e.g., second BT device 106) during an LM of the BT/BLE system architecture 400. The UART 432 may be configured to receive BT data (e.g., BT context information) from another BT device (e.g., second BT device 106) during an AM of the BT/BLE system architecture 400. The LP BT stack 418 may include an IPC 410 for communicating BT data with the IPC module 408 of the BT controller 406 during either a LM. The LP BT stack 418 may include an IPC 410 for communicating BT data with the IPC module 408 of the BT controller 406 during a LM.

The LP BT stack 418 may include any number of known BT profiles 428 or specifications that may define how BT data is transferred from one device (e.g., first BT device 102, system architecture 400) to another connected device (e.g., second BT device 106). The BT profiles 428 within the LP BT stack 418 may include, but are not limited to, profiles usable in LM, such as Advanced Audio Distribution Profile Source (A2DP Src) 428a, Audio/Video Distribution Transport Profile (AVDTP) 428b, Audio/Video Remote Control Profile (AVRCP) 428c, Audio/Video Control Transport Profile (AVCTP) 428d, Hands-Free Profile Hands-Free unit (HFP-HF) 428e, and LM Service Discovery Protocol (SDP) 428f. The LP BT stack 418 may further include an LM ATTribute (ATT) 426 protocol, an LM General ATT (GATT) 424, an LM RFCOMM (Radio frequency communication) 422, an LM L2CAP 416, and an LM Host Controller Interface (HCl) 414.

The LM GATT 424 and LM L2CAP 416 may configure a wireless connection via the LM HCl 414 using one of the BT profiles 428. The LM RFCOMM 422 is a set of transport protocols made on top of the LM L2CAP 416 providing emulated RS-232 serial ports. The LM GATT 424 may define the way in which two BT devices (e.g., first BT device 102, second BT device 106) transfer BT data back and forth using Profiles (e.g., BT Profiles 428), Services, and Characteristics during a low power mode. The LM GATT 424 may utilize LM ATT 426 to store Profiles, Services, Characteristics, and other BT context information related to the functions and operation of the LM BT applications 420 during a low power mode of the system architecture 400. In other words, the LM GATT 424 may configure how BT data is transferred across the wireless connection based on the LM ATT 426.

The AP BT stack 438 may include any number of known BT profiles 456 or specifications that may define how BT data is transferred from one device (e.g., first BT device 102, system architecture 400) to another connected device (e.g., second BT device 106). The BT profiles 456 within the AP BT stack 438 may include, but are not limited to, profiles usable in both LM and AM, such as A2DP Src 456b, AVDTP 456c, AVRCP 456d, AVCTP 456e, HFP-HF 456g, and AM SDP 456h, and profiles usable in active mode only such as A2DP Sink 456a, Hands-Free Profile Audio Gateway (HFP-AG) 456f, Human Interface Device profile (HID) 456h, and BT Offload profile 456i.

The AP BT stack 438 may further include an AM ATT/enhanced ATT (EATT) 454 protocol, an AM GATT 452, an AM RFCOMM 448, an AM L2CAP 444, and an AM HCl 442. The AM GATT 452 and AM L2CAP 444 may configure a wireless connection via the AM HCl 442 using one of the BT profiles 456. The AM RFCOMM 448 is a set of transport protocols made on top of the AM L2CAP 444 providing emulated RS-232 serial ports. The AM GATT 452 may define the way in which two BT devices (e.g., first BT device 102, second BT device 106) transfer BT data back and forth using Profiles (e.g., BT Profiles 456), Services, and Characteristics during a low power mode. The AM GATT 452 may utilize AM ATT/EATT 454 to store Profiles, Services, Characteristics, and other BT context information related to the functions and operation of the LM/AM BT applications 462 and AM BT applications 464 during an active power mode of the system architecture 400. In other words, the AM GATT 452 may configure how BT data is transferred across the wireless connection based on the AM ATT/EATT 454.

The application processor 402 may include one or more drivers and/or interfaces to communicate BT data with the UAR T432 of the BT controller 406. For example, the application processor 402 may include a kernel space that includes a multiple signal messages (MSM) UART driver 434 that is communicatively connected to the UART 432, and a teletypewriter (TTY)-driver 436 that is communicatively connected to the MSM UART driver 434. The AP BT stack 438 may include a BT-hardware abstraction layer (HAL) 440 that is configured to convey BT data with the TTY-driver and the AM HCl 442.

The low power processor 404 may include middleware 470 that communicates BT data from the LP BT stack 418 to the LM BT applications during a LM, and to an LM driver 472 during an active mode. The LM driver 472 may communicate BT data to the application processor 402 via a Glink 474. The Glink 474 may be in a Kernel space of the application processor 402 and may communicate BT data to a BTOffload HAL 475 in user space of the application processor 402. The BTOffload HAL 475 may relay the BT data to the BTOffload Service 476 and/or the BT Offload profile 456i.

In embodiments implementing a Common Profile, such as GAP or DIS, the Common Profile may be implemented by the LP BT stack 418.

In some embodiments, the BT controller 406 may be implemented to arbitrate GATT packets in a dual BT stack configuration by interfacing between the LP BT stack 418, the AP BT stack 438, and a remote device (i.e., remote GATT client or remote GATT server). In some embodiments, a processor or circuitry implementing an arbitration layer 490 may be implemented to arbitrate GATT packets in a dual BT stack configuration by interfacing between the LP BT stack 418, the AP BT stack 438, and a remote device (i.e., remote GATT client or remote GATT server).

In embodiments implementing the arbitration layer 490, the arbitration layer 490 may be implemented by the low power processor 404, within a subprocessor of the low power processor 404, as firmware, or as virtual software implemented by the low power processor 404. In some embodiments, the arbitration layer 490 may be configured to interface between various layers within the low power processor 404. For example, the arbitration layer 490 may be fully implemented within the BT controller 406, such that the arbitration layer 490 interfaces with the IPC 410 and the MSM UART driver 434 to route BT data accordingly. As another example, the arbitration layer may be implemented between the IPC module 408 and the UART 432 to interface with the IPC 410 and MSM UART driver 434 respectively, such that the arbitration layer 490 performs routing operations between the BT controller 406 and the LP BT stack 418 and the AP BT stack 438. As a further example, the arbitration layer 490 may be implemented within the LP BT stack 418 between the IPC 410 and the LM HCl 414 and between the UART 432 and the MSM UART driver 434.

In some embodiments, the BT controller 406, a processor or circuitry implementing the arbitration layer 490, and/or the BT controller 406 implementing the arbitration layer 490 may each be referred to generally as interface circuitry (e.g., 260, 492) for arbitrating GATT packets in a dual BT stack configuration by interfacing between the LP BT stack 418, the AP BT stack 438, and a remote device (i.e., remote GATT client or remote GATT server). Interface circuitry 492 within the low power processor 404 may implement the various embodiments. In some embodiments, the interface circuitry 492 may be configured to interface between various layers of the LP BT stack 418 and/or hardware within the low power processor 404. For example, the interface circuitry 492 may be fully implemented within the BT controller 406, such that the interface circuitry 492 interfaces with the IPC 410 and the MSM UART driver 434 to route BT data accordingly. As another example, the interface circuitry 492 may be implemented between the IPC module 408 and the UART 432 to interface with the IPC 410 and MSM UART driver 434 respectively, such that the interface circuitry 492 performs routing operations between the BT controller 406 and the LP BT stack 418 and the AP BT stack 438. As a further example, the arbitration layer 490 may be wholly implemented within the interface circuitry 492.

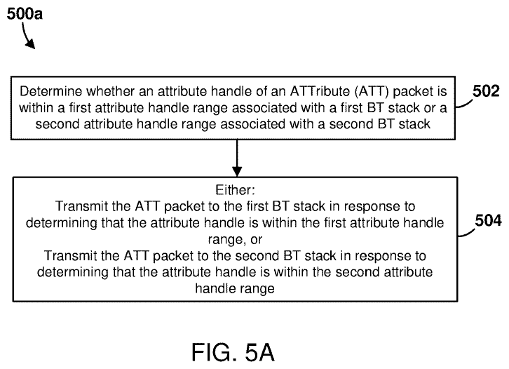

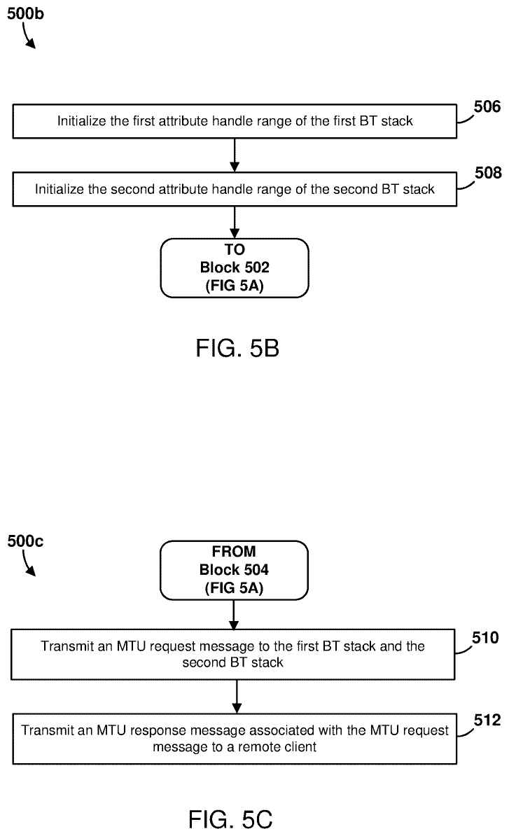

For purposes of FIGS. 5A-7B, a “first BT stack” and a “second BT stack” may interchangeably refer to either an LP BT stack 418 and/or an AP BT stack 438. For example, in one implementation, the first BT stack may refer to the LP BT stack 418 and the second BT stack may refer to the AP BT stack 438. In another implementation, the first BT stack may refer to the AP BT stack 438 and the second BT stack may refer to the LP BT stack 418.

FIG. 5A is a process flow diagram of an example method 500a for arbitrating GATT packets in a dual BT stack configuration of a GATT server in accordance with various embodiments. FIGS. 5B and 5C are process flow diagrams of example operations 500b and 500c that may be performed as part of the method 500a as described arbitrating GATT packets in a dual BT stack configuration of a GATT server in accordance with some embodiments. With reference to FIGS. 1-5C, the method 500a and the operations 500b and 500c may be performed by a computing device (e.g., 102, 200, 302, 400). In some embodiments, the computing device may be configured to perform the operations by processor-executable instructions stored in a non-transitory processor-readable medium (e.g., 220, 258, 320). Means for performing each of the operations of the method 500a and the operations 500b and 500c may be a processor of the systems 100, 200, 300, and 400 such as the processors 252, 322, 404, and/or the like as described with reference to FIGS. 1-5C.

In block 502, the computing device may perform operations including determining whether an attribute handle of an ATT packet is within a first attribute handle range associated with a first BT stack or a second attribute handle range associated with a second BT stack. A GATT server may be configured with pre-allocated attribute handle ranges for both the first BT stack and the second BT stack. The computing device may receive an attribute handle (i.e., as part of a response message from a GATT client) of an ATT packet, and may determine which attribute handle range the attribute handle falls within. The first attribute handle range may be a range between 0001 and FFFF hexadecimal, and the second attribute handle range may be a range between 0001 and FFFF hexadecimal that does not include the first attribute handle range (i.e., the remaining range unused by the first attribute handle range).

For example, the first attribute handle range may a range be from 0x0001 hexadecimal to 0x1000 hexadecimal, and the second attribute handle may be a range from 0x1001 hexadecimal to 0xFFFF hexadecimal. As another example, the first attribute handle range may a range be from 0x3001 hexadecimal to 0xFFFF hexadecimal, and the second attribute handle may be a range from 0x0001 hexadecimal to 0x3000 hexadecimal.

The first attribute handle range may be assigned to the first BT stack, and the second attribute handle range may be assigned to the second BT stack. Thus in block 502, upon receiving and identifying an attribute handle of a message received from a GATT client, the computing device may determine which of the attribute handle ranges the identified attribute handle falls within, and therefore which BT stack the ATT packet should be routed to.

In some embodiments, an ATT packet may include ATT opcode including a starting attribute handle and an ending attribute handle. In such embodiments, determining whether the attribute handle of the ATT packet is within the first attribute handle range or the second attribute handle range may include determining whether the starting attribute handle of the ATT packet is within the first attribute handle range or the second attribute handle range.

Means for performing the operations of block 502 may include a computing device (e.g., 102, 200, 302, 400) executing the interface module 330.

In block 504, the computing device may perform operations including either transmitting the ATT packet to the first BT stack in response to determining that the attribute handle is within the first attribute handle range, or transmitting the ATT packet to the second BT stack in response to determining that the attribute handle is within the second attribute handle range. For example, if the computing device determined that the attribute handle of the ATT packet is within an attribute handle range associated with the LP BT stack 418, the computing device may route the packet to the LP BT stack 418. As another example, if the computing device determined that the attribute handle of the ATT packet is within an attribute handle range associated with the AP BT stack 438, the computing device may route the ATT packet to the AP BT stack 438. Means for performing the operations of block 504 may include a computing device (e.g., 102, 200, 302, 400) executing the interface module 330 and/or the transmit-receive module 332.

FIG. 5B illustrates operation 500b that may be performed as part of the method 500a for arbitrating GATT packets in a dual BT stack configuration of a GATT server in accordance with some embodiments. With reference to FIGS. 1-5B, the computing device may perform operations including initializing the first attribute handle range of the first BT stack in block 506. The computing device may initialize a first attribute handle range for use in determining whether an attribute handle of an ATT packet should be routed to the first BT stack. Initialization of the first attribute handle range may occur during system configuration, such as upon system bootup, system restart, or system reconfiguration. Means for performing the operations of block 506 may include a computing device (e.g., 102, 200, 302, 400) executing the interface module 330 and/or the initialization module 336.

In block 508, the computing device may perform operations including initializing the second attribute handle range of the second BT stack, in which the second attribute handle range is different from the first attribute handle range. The computing device may initialize a second attribute handle range for use in determining whether an attribute handle of an ATT packet should be routed to the second BT stack. Initialization of the second attribute handle range may occur during system configuration, such as upon system bootup, system restart, or system reconfiguration. Means for performing the operations of block 506 may include a computing device (e.g., 102, 200, 302, 400) executing the interface module 330 and/or the initialization module 336.

Following the operations in block 508, the computing device may perform operations in block 502 as described.

FIG. 5C illustrates operation 500c that may be performed as part of the method 500a for arbitrating GATT packets in a dual BT stack configuration of a GATT server in accordance with some embodiments. With reference to FIGS. 1-5C, following the operations in block 504, the computing device may perform operations including transmitting an MTU request message (e.g., ATT_EXCHANGE_MTU_REQ) to the first BT stack and the second BT stack in block 510. Means for performing the operations of block 510 may include a computing device (e.g., 102, 200, 302, 400) executing the interface module 330 and/or the transmit-receive module 332.

In block 512, the computing device may perform operations including transmitting an MTU response message (e.g., ATT_EXCHANGE_MTU RSP) associated with the MTU request message to a remote client. Means for performing the operations of block 512 may include a computing device (e.g., 102, 200, 302, 400) executing the interface module 330 and/or the transmit-receive module 332.

In some embodiments, a first BT stack and a second BT stack in a dual BT stack configuration may be configured with a same MTU value. Thus, an MTU request message received by the computing device from a remote client may be conveyed to both the first BT stack and the second BT stack as described with reference to block 510. Both the first BT stack and the second BT stack may then transmit an MTU response message out to the remote client in response to the MTU request message. However, the computing device, via the interface circuitry 492 (e.g., BT controller 406, processor implementing arbitration layer 490, BT controller 406 implementing arbitration layer 490), may withhold or otherwise prevent the unnecessary transmission of both MTU response messages from the first BT stack and the second BT stack, and may instead transmit a single MTU response message to the remote client as described with reference to block 512, thereby conserving computational resources and time. The remote client remains unaffected by this process, as the remote client, which may be unaware of the dual BT stack configuration of the computing device, expected to receive a single MTU response message in return.

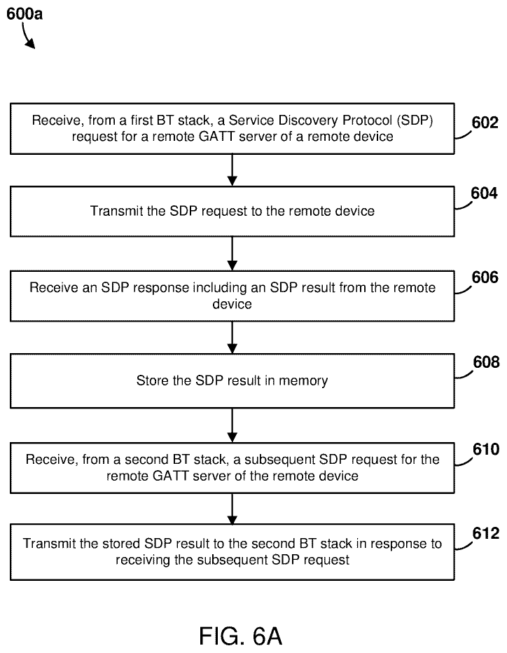

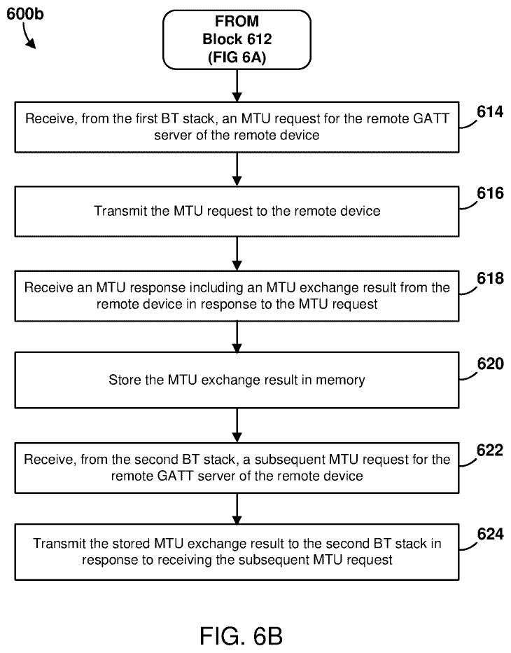

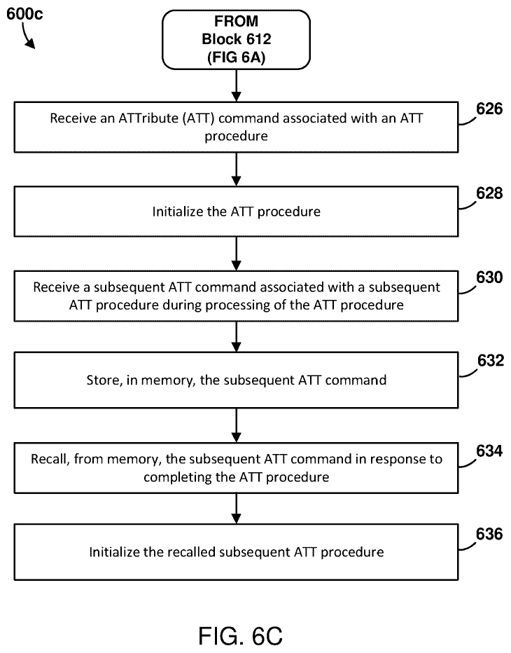

FIG. 6A is a process flow diagram of an example method 600a for arbitrating GATT packets in a dual BT stack configuration of a GATT client in accordance with various embodiments. FIGS. 6B and 6C are process flow diagrams of example operations 600b and 600c that may be performed as part of the method 600a as described arbitrating GATT packets in a dual BT stack configuration of a GATT client in accordance with some embodiments. With reference to FIGS. 1-6C, the method 600a and the operations 600b and 600c may be performed by a computing device (e.g., 102, 200, 302, 400). In some embodiments, the computing device may be configured to perform the operations by processor-executable instructions stored in a non-transitory processor-readable medium (e.g., 220, 258, 320). Means for performing each of the operations of the method 600a and the operations 600b and 600c may be a processor of the systems 100, 200, 300, and 400 such as the processors 252, 322, 404, and/or the like as described with reference to FIGS. 1-6C.

In block 602, the computing device may perform operations including receiving, from a first BT stack, a Service Discovery Protocol (SDP) request for a remote GATT server of a remote device. Means for performing the operations of block 602 may include a computing device (e.g., 102, 200, 302, 400) executing the interface module 330 and/or the transmit-receive module 332.

In block 604, the computing device may perform operations including transmitting the SDP request to the remote device. The remote device may be configured as a GATT server to communicate with the computing device configured as a GATT client. Means for performing the operations of block 604 may include a computing device (e.g., 102, 200, 302, 400) executing the interface module 330 and/or the transmit-receive module 332.

In block 606, the computing device may perform operations including receiving an SDP response including an SDP result from the remote device. The SDP response may be received from the remote device configured as a GATT server in response to the SDP request transmitted to the remote device. Means for performing the operations of block 606 may include a computing device (e.g., 102, 200, 302, 400) executing the interface module 330 and/or the transmit-receive module 332.

In block 608, the computing device may perform operations including storing the SDP result in memory. The SDP result may be stored in memory in preparation of reducing the number of SDP requests performed by the computing device. For example, any further SDP requests performed by another BT stack for the same remote device may not be necessary, and the computing device may instead transmit the SDP result of the initial SDP request to a BT stack initiating any subsequent SDP requests. Means for performing the operations of block 608 may include a computing device (e.g., 102, 200, 302, 400) executing the interface module 330 and/or the memory access module 334.

In block 610, the computing device may perform operations including receiving, from a second BT stack, a subsequent SDP request for the remote GATT server of the remote device. Means for performing the operations of block 610 may include a computing device (e.g., 102, 200, 302, 400) executing the interface module 330 and/or the transmit-receive module 332.

In block 612, the computing device may perform operations including transmitting the stored SDP result to the second BT stack in response to receiving the subsequent SDP request. Means for performing the operations of block 612 may include a computing device (e.g., 102, 200, 302, 400) executing the interface module 330 and/or the transmit-receive module 332.

To summarize the operations as described with reference to block 602-612, the computing device may maintain a record of SDP results of SDP requests for each remote device. In other words, the computing device may maintain a record of SDP results in an SDP result cache. The SDP result cache may be maintained to reduce the number of SDP requests performed for the same remote device. For example, a first BT stack of the computing device may initiate an SDP request to a remote GATT server, and the remote GATT server may respond with an SDP response message including an SDP result. The SDP result may be received by the computing device (i.e., interface module 330) and transmitted or otherwise conveyed to the first BT stack that initiated the SDP request.

Subsequently, a second BT stack of the computing device may need SDP results from the same remote device to perform various BT operations, and may initiate another SDP request to be transmitted to the remote device. The computing device may determine or otherwise identify that the subsequent SDP request is for the same connection to the same remote server as the initial SDP request and is therefore requesting the same SDP result stored in the SDP result cache. Thus, instead of transmitting the subsequent SDP request to the remote device which would yield the same SDP result as the initial SDP request from the first BT stack, the computing device may halt or otherwise eliminate the subsequent SDP request, and simply transmit the SDP result directly to the second BT stack, therefore eliminating the need to perform a repetitive SDP request.

FIG. 6B illustrates operation 600b that may be performed as part of the method 600a for arbitrating GATT packets in a dual BT stack configuration of a GATT client in accordance with some embodiments. With reference to FIGS. 1-6B, following the operations in block 612, the computing device may perform operations including receiving, from the first BT stack, an MTU request (e.g., ATT EXCHANGE MTU REQ) for the remote GATT server of the remote device in block 614. Means for performing the operations of block 614 may include a computing device (e.g., 102, 200, 302, 400) executing the interface module 330 and/or the transmit-receive module 332.

In block 616, the computing device may perform operations including transmitting the MTU request to the remote device. The remote device may be configured as a GATT server to communicate with the computing device configured as a GATT client. Means for performing the operations of block 616 may include a computing device (e.g., 102, 200, 302, 400) executing the interface module 330 and/or the transmit-receive module 332.

In block 618, the computing device may perform operations including receiving an MTU response (e.g., ATT_EXCHANGE_MTU_RSP) including an MTU exchange result from the remote device in response to the MTU request. The MTU response may be received from the remote device configured as a GATT server in response to the MTU request transmitted to the remote device. Means for performing the operations of block 618 may include a computing device (e.g., 102, 200, 302, 400) executing the interface module 330 and/or the transmit-receive module 332.

In block 620, the computing device may perform operations including storing the MTU exchange result in memory. The MTU exchange result may be stored in memory in preparation of reducing the number of MTU requests performed by the computing device. For example, any further MTU requests performed by another BT stack for the same remote device may not be necessary, and the computing device may instead transmit the MTU exchange result of the initial MTU request to a BT stack initiating any subsequent MTU requests. Means for performing the operations of block 620 may include a computing device (e.g., 102, 200, 302, 400) executing the interface module 330 and/or the memory access module 334.

In block 622, the computing device may perform operations including receiving, from the second BT stack, a subsequent MTU request for the remote GATT server of the remote device. Means for performing the operations of block 622 may include a computing device (e.g., 102, 200, 302, 400) executing the interface module 330 and/or the transmit-receive module 332.

In block 624, the computing device may perform operations including transmitting the stored MTU exchange result to the second BT stack in response to receiving the subsequent MTU request. Means for performing the operations of block 624 may include a computing device (e.g., 102, 200, 302, 400) executing the interface module 330 and/or the transmit-receive module 332.

The operations described with reference to blocks 614-624 may be performed in a similar manner and with a similar purpose (i.e., reduce total number of request procedures with remote GATT server) as the operations as described with reference to blocks 602-612. To summarize the operations described with reference to blocks 614-624, the computing device may maintain a record of MTU exchange results of MTU requests for each remote device. In other words, the computing device may maintain a record of MTU exchange results in an MTU exchange result cache. The MTU exchange result cache may be maintained to reduce the number of MTU requests performed for the same remote device. For example, a first BT stack of the computing device may initiate an MTU request to a remote GATT server, and the remote GATT server may respond with an MTU response message including an MTU exchange result. The MTU exchange result may be received by the computing device (i.e., via interface circuitry 492) and transmitted or otherwise conveyed to the first BT stack that initiated the MTU request. Subsequently, a second BT stack of the computing device may need MTU exchange results from the same remote device to perform various BT operations, and may initiate another MTU request to be transmitted to the remote device. The computing device may determine or otherwise identify that the subsequent MTU request is for the same connection to the same remote server as the initial MTU request and is therefore requesting the same MTU exchange result stored in the MTU exchange result cache. Thus, instead of transmitting the subsequent MTU request to the remote device which would yield the same MTU exchange result as the initial MTU request from the first BT stack, the computing device may halt or otherwise eliminate the subsequent MTU request, and simply transmit the MTU exchange result directly to the second BT stack, therefore eliminating the need to perform a repetitive MTU request.

FIG. 6C illustrates operation 600c that may be performed as part of the method 600a for arbitrating GATT packets in a dual BT stack configuration of a GATT client in accordance with some embodiments. With reference to FIGS. 1-6C, following the operations in block 612, the computing device may perform operations including receiving an ATT command associated with an ATT procedure in block 626. Means for performing the operations of block 626 may include a computing device (e.g., 102, 200, 302, 400) executing the interface module 330 and/or the transmit-receive module 332.

In block 628, the computing device may perform operations including initializing the ATT procedure. Initializing the ATT procedure may include beginning one or more processes or operations included in the ATT procedure. Means for performing the operations of block 628 may include a computing device (e.g., 102, 200, 302, 400) executing the interface module 330 and/or the initialization module 336.

In block 630, the computing device may perform operations including receiving a subsequent ATT command associated with a subsequent ATT procedure during processing of the ATT procedure. The subsequent ATT command may be processed after the completion of the ATT procedure previously received and initialized. Means for performing the operations of block 630 may include a computing device (e.g., 102, 200, 302, 400) executing the interface module 330 and/or the transmit-receive module 332.

In block 632, the computing device may perform operations including storing, in memory, the subsequent ATT command. Means for performing the operations of block 632 may include a computing device (e.g., 102, 200, 302, 400) executing the interface module 330 and/or the memory access module 334.

In block 634, the computing device may perform operations including recalling, from memory, the subsequent ATT command in response to completing the ATT procedure. Means for performing the operations of block 634 may include a computing device (e.g., 102, 200, 302, 400) executing the interface module 330 and/or the memory access module 334.

In block 636, the computing device may perform operations including initializing the recalled subsequent ATT procedure. The recalled subsequent ATT procedure may therefore be executed after the initial ATT procedure has been initialized and executed. Means for performing the operations of block 636 may include a computing device (e.g., 102, 200, 302, 400) executing the interface module 330 and/or the initialization module 336.

To summarize the operations of blocks 626-636, an interface circuitry 492 (e.g., BT controller 406, processor implementing arbitration layer 490, BT controller 406 implementing arbitration layer 490) may record all ATT procedures for each connection to a remote device. When the interface circuitry 492 receives a request to perform an ATT procedure from a BT stack (e.g., LP BT stack 418 and/or AP BT stack 438) while another ongoing ATT procedure is being processing, the interface circuitry 492 may store the ATT procedure, and any further ATT procedures received, in memory. In some embodiments, the ATT procedure(s) may be stored in a memory at predetermined addresses or address ranges. In some embodiments, ATT procedure(s) may be stored in memory in a first-in first-out (FIFO) queue, in which an ATT procedure is sent to the back of the FIFO queue. For example, while an ATT procedure is being performed, the interface circuitry 492 may receive a subsequent ATT procedure from any BT stack, and the interface circuitry 492 may store the subsequent ATT procedure in a FIFO queue. The interface circuitry 492 may then receive one or more further ATT procedures from any BT stack, and the interface circuitry 492 may store the one or more further ATT procedures in the FIFO queue behind the first ATT procedure recorded in the FIFO queue. Thus, the first ATT procedure in the FIFO queue may be performed after the ongoing ATT procedure is completed, followed by any additional ATT procedures in the FIFO queue in order or receipt by the interface circuitry 492.

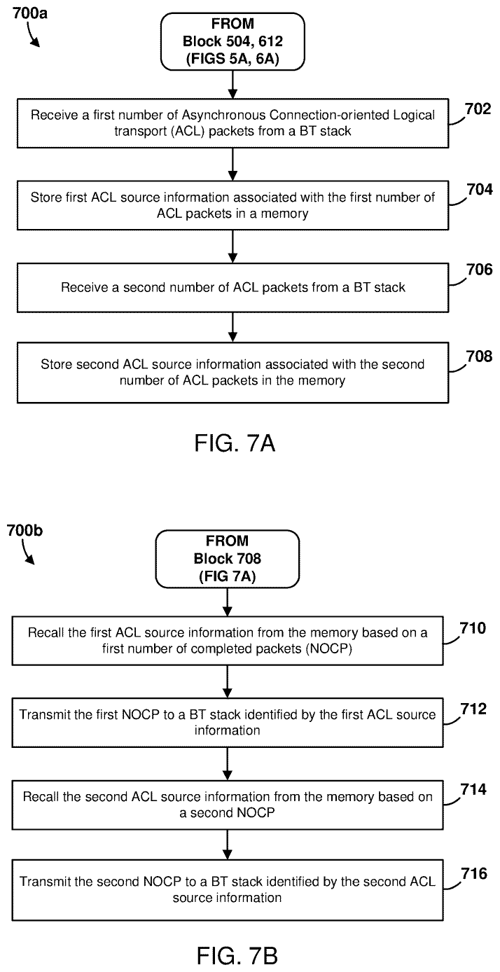

FIGS. 7A and 7B are process flow diagrams of example operations 700a and 700b that may be performed as part of the methods 500a and 600a as described arbitrating GATT packets in a dual BT stack configuration of a GATT server and/or GATT client in accordance with some embodiments. With reference to FIGS. 1-7B, the operations 700a and 700b may be performed by a computing device (e.g., 102, 200, 302, 400). In some embodiments, the computing device may be configured to perform the operations by processor-executable instructions stored in a non-transitory processor-readable medium (e.g., 220, 258, 320). Means for performing each of the operations 700a and 700b may be a processor of the systems 100, 200, 300, and 400 such as the processors 252, 322, 404, and/or the like as described with reference to FIGS. 1-7B.

FIG. 7A illustrates operation 700a that may be performed as part of the methods 500a and/or 600a for arbitrating GATT packets in a dual BT stack configuration of a GATT server and/or GATT client in accordance with some embodiments. With reference to FIGS. 1-7A, following the operations in block 504 and/or block 612, the computing device may perform operations including receiving a first number of Asynchronous Connection-oriented Logical transport (ACL) packets from a BT stack (e.g., LP BT stack 418 or AP BT stack 538) in block 702. Means for performing the operations of block 702 may include a computing device (e.g., 102, 200, 302, 400) executing the interface circuitry 492 and/or the transmit-receive module 332.

In block 704, the computing device may perform operations including storing first ACL source information associated with the first number of ACL packets in a memory. Means for performing the operations of block 704 may include a computing device (e.g., 102, 200, 302, 400) executing the interface module 330 and/or the memory access module 334.

In block 706, the computing device may perform operations including receiving a second number of ACL packets from a BT stack. Means for performing the operations of block 706 may include a computing device (e.g., 102, 200, 302, 400) executing the interface module 330 and/or the transmit-receive module 332.

In block 708, the computing device may perform operations including storing second ACL source information associated with the second number of ACL packets in the memory. Means for performing the operations of block 708 may include a computing device (e.g., 102, 200, 302, 400) executing the interface module 330 and/or the memory access module 334.

To summarize the operations of blocks 702-708, an interface circuitry 492 (e.g., BT controller 406, processor implementing arbitration layer 490, BT controller 406 implementing arbitration layer 490) may record all ACL packet information for each connection to a remote device. When the interface circuitry 492 receives an ACL packet from a BT stack (e.g., LP BT stack 418 and/or AP BT stack 438), the interface circuitry 492 may store ACL source information indicating which BT stack the ACL packet originated from. In some embodiments, the ACL source information may be stored in a memory at predetermined addresses or address ranges. In some embodiments, ACL source information may be stored in memory in a first-in first-out (FIFO) queue, in which the ACL source information from a most recently received ACL packet is sent to the back of the FIFO queue. For example, the interface circuitry 492 may receive one or more ACL packets from the second BT stack, and the interface circuitry 492 may store the ACL source information associated with the one or more ACL packets in a FIFO queue. The interface circuitry 492 may then receive one or more subsequent ACL packets from the first BT stack, and the interface circuitry 492 may store the ACL source information associated with the one or more subsequent ACL packets in the FIFO queue behind the first set of ACL source information recorded in the FIFO queue, such that the ACL source information associated with the one or more ACL packets received from the second BT stack are at the front of the queue. These operations may be performed in preparation of transmitting the appropriate NOCP to the correct BT stack.

FIG. 7B illustrates operation 700b that may be performed as part of the methods 500a and/or 600a for arbitrating GATT packets in a dual BT stack configuration of a GATT server and/or GATT client in accordance with some embodiments. With reference to FIGS. 1-7b, following the operations in block 708, the computing device may perform operations including recalling the first ACL source information from the memory based on a first NOCP in block 710. Means for performing the operations of block 710 may include a computing device (e.g., 102, 200, 302, 400) executing the interface module 330 and/or the memory access module 334.

In block 712, the computing device may perform operations including transmitting the first NOCP to a BT stack identified by the first ACL source information. Means for performing the operations of block 712 may include a computing device (e.g., 102, 200, 302, 400) executing the interface module 330 and/or the transmit-receive module 332.

In block 714, the computing device may perform operations including recalling the second ACL source information from the memory based on a second NOCP. Means for performing the operations of block 714 may include a computing device (e.g., 102, 200, 302, 400) executing the interface module 330 and/or the memory access module 334.

In block 716, the computing device may perform operations including transmitting the second NOCP to a BT stack identified by the second ACL source information. Means for performing the operations of block 716 may include a computing device (e.g., 102, 200, 302, 400) executing the interface module 330 and/or the transmit-receive module 332.

To summarize the operations of blocks 710-716, an interface circuitry 492 (e.g., BT controller 406, processor implementing arbitration layer 490, BT controller 406 implementing arbitration layer 490) may recall ACL source information from memory in order of the ACL information being recorded in the memory. The computing device may be triggered to recall ACL information stored in memory when transmitting NOCP for quality assurance. When transmitting a NOCP to a BT stack, the interface circuitry 492 may dequeue the stored ACL source information in order of the ACL information in order of recordation and by a number of items equal to the NOCP. For example, the interface circuitry 492 may initiate transmitting NOCP (i.e., the NOCP transmitted to a remote device) and may recall a number of items (i.e., ACL source information) from memory. In embodiments, implementing a FIFO queue, the interface circuitry 492 may dequeue the front of the FIFO queue (i.e., FIFO queue is identified by a connection handle corresponding to a remote device, in which each connection handle for each remote device is associated with its own queue or memory space) by a number of items equal to the NOCP. The interface circuitry 492 may analyze the dequeued items to determine the ACL source information, and may then transmit the NOCP to the BT stack identified by the ACL source information. The process may repeat until all items with a queue have been dequeued and a NOCP is transmitted to the appropriate BT stack according to the ACL source information within the queue.

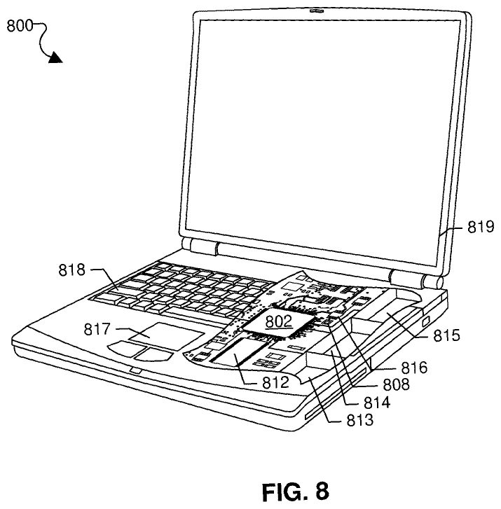

Various embodiments (including, but not limited to, embodiments described above with reference to FIGS. 1-7B) may be implemented in a wide variety of computing systems include a laptop computer 800, an example of which is illustrated in FIG. 8. With reference to FIGS. 1-8, a laptop computer will typically include a processor 802 coupled to volatile memory 812 and a large capacity nonvolatile memory, such as a disk drive 813 of Flash memory. Additionally, the computer 800 may have one or more antenna 808 for sending and receiving electromagnetic radiation that may be connected to a wireless data link and/or cellular telephone transceiver 816 coupled to the processor 802. The computer 800 may also include a BT transceiver 814 and a compact disc (CD) drive 815 coupled to the processor 802. The laptop computer 800 may include a touchpad 817, a keyboard 818, and a display 819 all coupled to the processor 802. Other configurations of the computing device may include a computer mouse or trackball coupled to the processor (e.g., via a USB input) as are well known, which may also be used in conjunction with the various embodiments.

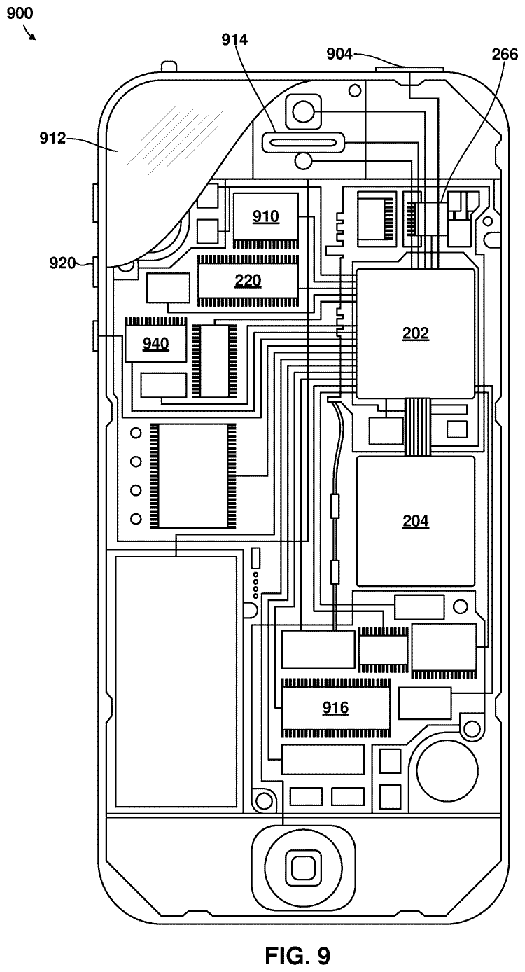

FIG. 9 is a component block diagram of a computing device 900 suitable for use with various embodiments. With reference to FIGS. 1-9, various embodiments may be implemented on a variety of computing devices 900 (e.g., 102, 200, 302, 400), an example of which is illustrated in FIG. 9 in the form of a smartphone. The computing device 900 may include a first circuitry 202 coupled to a second circuitry 204. The first and second SoCs 202, 204 may be coupled to internal memory 916, a display 912, and to a speaker 914. The first and second circuitries 202, 204 may also be coupled to at least one SIM 940 and/or a SIM interface that may store information supporting a first 5GNR subscription and a second 5GNR subscription, which support service on a 5G non-standalone (NSA) network.

The computing device 900 may include an antenna 904 for sending and receiving electromagnetic radiation that may be connected to a wireless transceiver 266 coupled to one or more processors in the first and/or second circuitries 202, 204. The computing device 900 may also include menu selection buttons or rocker switches 920 for receiving user inputs.

The computing device 900 also includes a sound encoding/decoding (CODEC) circuit 910, which digitizes sound received from a microphone into data packets suitable for wireless transmission and decodes received sound data packets to generate analog signals that are provided to the speaker to generate sound. Also, one or more of the processors in the first and second circuitries 202, 204, wireless transceiver 266 and CODEC 910 may include a digital signal processor (DSP) circuit (not shown separately).

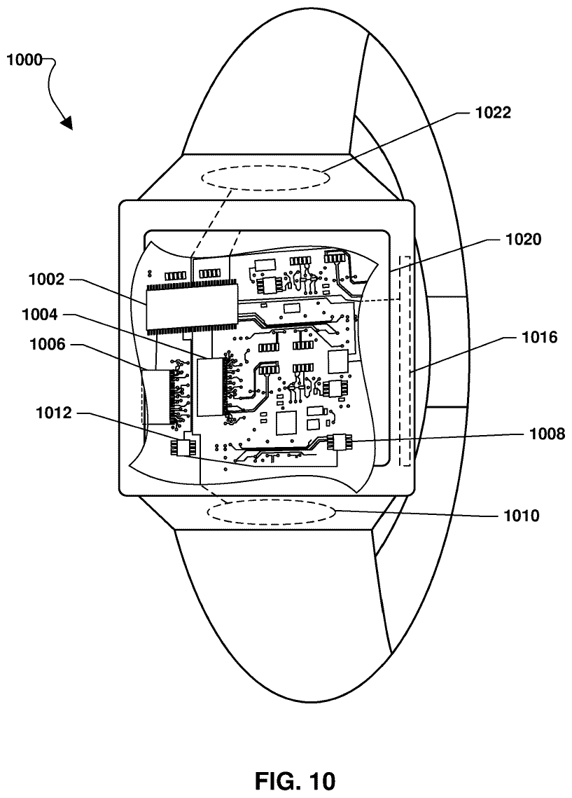

The various embodiments may be implemented within a variety of computing devices, such as a wearable computing device. FIG. 10 illustrates an example wearable computing device in the form of a smart watch 1000 according to some embodiments. A smart watch 1000 may include an SoC 1002 including two or more processors (e.g., application processor, low power processor) coupled to internal memories 1004 and 1006. Internal memories 1004, 1006 may be volatile or non-volatile memories, and may also be secure and/or encrypted memories, or unsecure and/or unencrypted memories, or any combination thereof. The SoC 1002 may also be coupled to a touchscreen display 1020, such as a resistive-sensing touchscreen, capacitive-sensing touchscreen infrared sensing touchscreen, or the like. Additionally, the smart watch 1000 may have one or more antenna 1008 for sending and receiving electromagnetic radiation that may be connected to one or more wireless data links 1012, such as one or more Bluetooth® transceivers, Peanut transceivers, Wi-Fi transceivers, ANT+ transceivers, etc., which may be coupled to the SoC 1002. The smart watch 1000 may also include physical virtual buttons 1022 and 1010 for receiving user inputs as well as a slide sensor 1016 for receiving user inputs.

The touchscreen display 1020 may be coupled to a touchscreen interface module that is configured receive signals from the touchscreen display 1020 indicative of locations on the screen where a user's fingertip or a stylus is touching the surface and output to the SoC 1002 information regarding the coordinates of touch events. Further, the SoC 1002 may be configured with processor-executable instructions to correlate images presented on the touchscreen display 1020 with the location of touch events received from the touchscreen interface module in order to detect when a user has interacted with a graphical interface icon, such as a virtual button.

The SoC 1002 may be any programmable microprocessor, microcomputer or multiple processor chip or chips that can be configured by software instructions (applications) to perform a variety of functions, including the functions of the various embodiments. In some devices, multiple processors may be provided, such as one processor dedicated to wireless communication functions and one processor dedicated to running other applications. Typically, software applications may be stored in an internal memory before they are accessed and loaded into the SoC 1002. The SoC 1002 may include internal memory sufficient to store the application software instructions. In many devices the internal memory may be a volatile or nonvolatile memory, such as flash memory, or a mixture of both. For the purposes of this description, a general reference to memory refers to memory accessible by the SoC 1002 including internal memory or removable memory plugged into the mobile device and memory within the SoC 1002 itself.

The processors of the computer 800, the computing device 900, and the smart watch 1000 may be any programmable microprocessor, microcomputer, or multiple processor chip or chips that can be configured by software instructions (applications) to perform a variety of functions, including the functions of the various embodiments described. In some mobile devices, multiple processors may be provided, such as one processor within a first circuitry 204 dedicated to wireless communication functions and one processor within a second circuitry 202 dedicated to running other applications. Software applications may be stored in the memory 220, 258, 320, 916 before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a processor of a computing device configured as a GATT server for arbitrating GATT packets in a dual BT stack configuration, including: determining whether an attribute handle of an ATT packet is within a first attribute handle range associated with a first BT stack or a second attribute handle range associated with a second BT stack; and either: transmitting the ATT packet to the first BT stack in response to determining that the attribute handle is within the first attribute handle range; or transmitting the ATT packet to the second BT stack in response to determining that the attribute handle is within the second attribute handle range.

Example 2. The method of example 1, further including: initializing the first attribute handle range of the first BT stack; and initializing the second attribute handle range of the second BT stack, in which the second attribute handle range is different from the first attribute handle range.

Example 3. The method of any of examples 1-2, in which the first attribute handle range is a range between 0001 and FFFF hexadecimal, and the second attribute handle range is a range between 0001 and FFFF hexadecimal that does not include the first attribute handle range.

Example 4. The method of any of examples 1-3, in which: the ATT packet includes ATT opcode including a starting attribute handle and an ending attribute handle; and determining whether the attribute handle of the ATT packet is within the first attribute handle range or the second attribute handle range includes determining whether the starting attribute handle of the ATT packet is within the first attribute handle range or the second attribute handle range.

Example 5. The method of any of examples 1-4, in which: the first BT stack and the second BT stack are configured with a same MTU value; and the method further includes: transmitting an MTU request message to the first BT stack and the second BT stack; and transmitting an MTU response message associated with the MTU request message to a remote client.

Example 6. The method of any of examples 1-5, further including: receiving a first number of ACL packets from a BT stack; storing first ACL source information associated with the first number of ACL packets in a memory; receiving a second number of ACL packets from a BT stack; and storing second ACL source information associated with the second number of ACL packets in the memory.

Example 7. The method of example 6, further including: recalling the first ACL source information from the memory based on a first NOCP; transmitting the first NOCP to a BT stack identified by the first ACL source information; recalling the second ACL source information from the memory based on a second NOCP; and transmitting the second NOCP to a BT stack identified by the second ACL source information.

Example 8. A method performed by a processor of a computing device configured as a GATT client for arbitrating GATT packets in a dual BT stack configuration of a GATT client, including: receiving, from a first BT stack, an SDP request for a remote GATT server of a remote device; transmitting the SDP request to the remote device; receiving an SDP response including an SDP result from the remote device; storing the SDP result in memory; receiving, from a second BT stack, a subsequent SDP request for the remote GATT server of the remote device; and transmitting the stored SDP result to the second BT stack in response to receiving the subsequent SDP request.

Example 9. The method of example 8, in which: the first BT stack and the second BT stack are configured with a same MTU value; and the method further includes: receiving, from the first BT stack, an MTU request for the remote GATT server of the remote device; transmitting the MTU request to the remote device; receiving an MTU response including an MTU exchange result from the remote device in response to the MTU request; storing the MTU exchange result in memory; receiving, from the second BT stack, a subsequent MTU request for the remote GATT server of the remote device; and transmitting the stored MTU exchange result to the second BT stack in response to receiving the subsequent MTU request.

Example 10. The method of any of examples 8-9, further including: receiving an ATT command associated with an ATT procedure; initializing the ATT procedure; receiving a subsequent ATT command associated with a subsequent ATT procedure during processing of the ATT procedure; storing in memory the subsequent ATT command; recalling from memory the subsequent ATT command in response to completing the ATT procedure; and initializing the recalled subsequent ATT procedure.

Example 11. The method of any of examples 8-10, further including: receiving a first number of ACL packets from a BT stack; storing first ACL source information associated with the first number of ACL packets in memory; receiving a second number of ACL packets from a BT stack; and storing second ACL source information associated with the second number of ACL packets in the memory.
Example 12. The method of example 11, further including: recalling the first ACL source information from the memory based on a first NOCP; transmitting the first NOCP to a BT stack identified by the first ACL source information; recalling the second ACL source information from the memory based on a second NOCP; and transmitting the second NOCP to a BT stack identified by the second ACL source information.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), Long Term Evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general Packet Radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (TCUASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A computing device, comprising
a first processor including a first Bluetooth (BT) stack associated with a first attribute handle range;
a second processor including a second BT stack associated with a second attribute handle range; and
interface circuitry communicatively coupled to the first BT stack and the second BT stack, wherein the interface circuitry is configured to:
determine whether an attribute handle of an ATTribute (ATT) packet is within the first attribute handle range or the second attribute handle range; and either:
transmit the ATT packet to the first BT stack in response to determining that the attribute handle is within the first attribute handle range, or
transmit the ATT packet to the second BT stack in response to determining that the attribute handle is within the second attribute handle range.

2. The computing device of claim 1, wherein the interface circuitry is further configured to:
initialize the first attribute handle range of the first BT stack; and
initialize the second attribute handle range of the second BT stack, wherein the second attribute handle range is different from the first attribute handle range.

3. (canceled)

4. The computing device of claim 1, wherein:
the ATT packet includes ATT opcode including a starting attribute handle and an ending attribute handle; and
the interface circuitry is configured to determine whether the attribute handle of the ATT packet is within the first attribute handle range or the second attribute handle range based on whether the starting attribute handle of the ATT packet is within the first attribute handle range or the second attribute handle range.

5. The computing device of claim 1, wherein:
the first BT stack and the second BT stack are configured with a same Maximum Transmission Unit (MTU) value; and
the interface circuitry is further configured to:
transmit an MTU request message to the first BT stack and the second BT stack; and
transmit an MTU response message associated with the MTU request message to a remote client.

6. The computing device of claim 1, wherein the second processor manages a Common Profile including at least one of a General Access Profile (GAP) service or a Device Information Service (DIS).

7. The computing device of claim 1, wherein the interface circuitry is further configured to:
receive a first number of Asynchronous Connection-oriented Logical transport (ACL) packets from a BT stack;
store first ACL source information associated with the first number of ACL packets in a memory;
receive a second number of ACL packets from a BT stack; and
store second ACL source information associated with the second number of ACL packets in the memory.

8. The computing device of claim 7, wherein the interface circuitry is further configured to:
recall the first ACL source information from the memory based on a first number of completed packets (NOCP);
transmit the first NOCP to a BT stack identified by the first ACL source information;
recall the second ACL source information from the memory based on a second NOCP; and
transmit the second NOCP to a BT stack identified by the second ACL source information.

9. The computing device of claim 1, wherein the interface circuitry is one of a BT controller or a processor implementing an arbitration layer within one of the first processor or second processor.

10. A computing device, comprising:
a first processor including a first Bluetooth (BT) stack;
a second processor including a second BT stack; and
interface circuitry communicatively coupled to the first BT stack and the second BT stack, wherein the interface circuitry is configured to:
receive, from the first BT stack, a Service Discovery Protocol (SDP) request for a remote General ATTribute (GATT) server of a remote device;
transmit the SDP request to the remote device;
receive an SDP response including an SDP result from the remote device;
store the SDP result in memory;
receive, from the second BT stack, a subsequent SDP request for the remote GATT server of the remote device; and
transmit the stored SDP result to the second BT stack in response to receiving the subsequent SDP request.

11. The computing device of claim 10, wherein the interface circuitry is further configured to transmit the SDP result to the first BT stack.

12. The computing device of claim 10, wherein:
the first BT stack and the second BT stack are configured with a same Maximum Transmission Unit (MTU) value; and
the interface circuitry is further configured to:
receive, from the first BT stack, an MTU request for a remote General ATTribute (GATT) server of the remote device;
transmit the MTU request to the remote device;
receive an MTU response including an MTU exchange result from the remote device in response to the MTU request;
store the MTU exchange result in memory;
receive, from the second BT stack, a subsequent MTU request for the remote GATT server of the remote device; and
transmit the stored MTU exchange result to the second BT stack in response to receiving the subsequent MTU request.

13. The computing device of claim 10, wherein the interface circuitry is further configured to:
receive an ATTribute (ATT) command associated with an ATT procedure;
initialize the ATT procedure;
receive a subsequent ATT command associated with a subsequent ATT procedure during processing of the ATT procedure;
store, in memory, the subsequent ATT command;
recall, from memory, the subsequent ATT command in response to completing the ATT procedure; and
initialize the recalled subsequent ATT procedure.

14. The computing device of claim 10, wherein the interface circuitry is further configured to:
receive a first number of Asynchronous Connection-oriented Logical transport (ACL) packets from a BT stack;
store first ACL source information associated with the first number of ACL packets in memory;
receive a second number of ACL packets from a BT stack; and
store second ACL source information associated with the second number of ACL packets in the memory.

15. The computing device of claim 14, wherein the interface circuitry is further configured to:
recall the first ACL source information from the memory based on a first number of completed packets (NOCP);
transmit the first NOCP to a BT stack identified by the first ACL source information;
recall the second ACL source information from the memory based on a second NOCP; and
transmit the second NOCP to a BT stack identified by the second ACL source information.

16. The computing device of claim 10, wherein the interface circuitry is one of a BT controller or a processor implementing an arbitration layer within one of the first processor or second processor.

17-24. (canceled)

25. A method performed by a processor of a computing device configured as a General ATTribute (GATT) client for arbitrating GATT packets in a dual Bluetooth (BT) stack configuration of a GATT client, comprising:
receiving, from a first BT stack, a Service Discovery Protocol (SDP) request for a remote GATT server of a remote device;
transmitting the SDP request to the remote device;
receiving an SDP response including an SDP result from the remote device;
storing the SDP result in memory;
receiving, from a second BT stack, a subsequent SDP request for the remote GATT server of the remote device; and
transmitting the stored SDP result to the second BT stack in response to receiving the subsequent SDP request.

26. The method of claim 25, wherein:
the first BT stack and the second BT stack are configured with a same Maximum Transmission Unit (MTU) value; and
the method further comprises:
receiving, from the first BT stack, an MTU request for the remote GATT server of the remote device;
transmitting the MTU request to the remote device;
receiving an MTU response including an MTU exchange result from the remote device in response to the MTU request;
storing the MTU exchange result in memory;
receiving, from the second BT stack, a subsequent MTU request for the remote GATT server of the remote device; and
transmitting the stored MTU exchange result to the second BT stack in response to receiving the subsequent MTU request.

27. The method of claim 25, further comprising:
receiving an ATTribute (ATT) command associated with an ATT procedure;
initializing the ATT procedure;
receiving a subsequent ATT command associated with a subsequent ATT procedure during processing of the ATT procedure;
storing in memory the subsequent ATT command;
recalling from memory the subsequent ATT command in response to completing the ATT procedure; and
initializing the recalled subsequent ATT procedure.

28. The method of claim 25, further comprising:
receiving a first number of Asynchronous Connection-oriented Logical transport (ACL) packets from a BT stack;
storing first ACL source information associated with the first number of ACL packets in memory;
receiving a second number of ACL packets from a BT stack; and
storing second ACL source information associated with the second number of ACL packets in the memory.

29. The method of claim 28, further comprising:
recalling the first ACL source information from the memory based on a first number of completed packets (NOCP);
transmitting the first NOCP to a BT stack identified by the first ACL source information;
recalling the second ACL source information from the memory based on a second NOCP; and
transmitting the second NOCP to a BT stack identified by the second ACL source information.
